(19) United States
(12) Patent Application Publication
(10) Pub. No.: US 2025/0308293 A1
(43) Pub. Date: Oct. 2, 2025

(54) Seamless Wireless Transmission of Diagnostic Data

(71) Applicant: Robert Bosch GmbH, Stuttgart (DE)

(72) Inventor: Himanshu Gusain, Owatonna, MN (US)

(21) Appl. No.: 18/624,910

(22) Filed: Apr. 2, 2024

(51) Int. Cl. G07C 5/00; H04W 4/40

(52) U.S. Cl. CPC G07C 5/008; G07C 5/0816; H04W 4/40

(57) ABSTRACT

A system and method for seamless transition between wireless data transmission channels and protocols in a diagnostic system performing a service action on a vehicle having a vehicle communication interface (VCI). A measurement of channel quality conditions is utilized to generate a best channel indicator, and the diagnostic system utilizes the best channel for transmission while retaining the other available channels in a standby operating mode. In response to a change in the best channel indication, the system switches to the updated best channel without interruption of the functions within an application layer of the diagnostic system, providing a seamless experience for the user.

### TECHNICAL FIELD

This disclosure relates to vehicular diagnostics.

### BACKGROUND

Modern automobiles utilize a bus to interface with a diagnostic processor during service of the vehicle. The automobile uses a vehicle communication interface (VCI) to exchange data, diagnostic information, and commands with a diagnostic tool external to the vehicle during a service action. Increasingly, wireless communication channels are utilized to accomplish this data exchange, which are susceptible to interference. However, different wireless transmission standards experience different degrees of interference in different operating conditions.

### SUMMARY

One aspect of this disclosure is directed to a diagnostic system comprising a diagnostic processor having an application layer, an abstraction layer, and a connection layer. The connection layer is in data communication with a vehicle communication interface (VCI) via a plurality of communication channels, each of the communication channels utilizing a distinct communication protocol. The abstraction layer monitors a quality indicator of each of the plurality of communication channels, generates a best channel indicator indicating the channel with the best quality, and selects a determined best channel correspondingly. The connection layer utilizes the best channel to transfer data between the VCI and the diagnostic processor. The abstraction layer transfers data between connection layer and the application layer. In some embodiments, the abstraction layer iteratively monitors the quality indicator of each of the plurality of communication channels, and updates the best channel indicator in each iteration, updating the best channel based upon each iterative best channel indicator.

Another aspect of this disclosure is directed to a method of selecting a wireless connection between a diagnostic processor and a vehicle communication interface (VCI), the diagnostic processor comprising an application layer, an abstraction layer, and a connection layer. The method comprises: establishing in the connection layer a plurality of wireless communication channels between the connection layer and the VCI, generating in the abstraction layer a plurality of quality indicators for each of the communication channels, designating the communication channel with the highest associated quality indicator as a best communication channel, and transmitting data between the application layer and the VCI using the best communication channel. Each quality indicator indicates the transmission conditions of its respective communication channel. The data transmitted from the VCI is passed through the connection layer and abstraction layer to the application layer and the data transmitted from the application layer is passed through the abstraction layer and the connection layer to the VCI. In some embodiments the steps of designating the best communication channel and transmitting data using the best communication channel are performed iteratively, with the designation of the best communication channel is updated in each iteration based on the quality indicators during the instant iteration.

A further aspect of this disclosure is directed to a non-transitory computer-readable medium having instructions stored thereon that when read by a processor cause the processor to perform a method of selecting a wireless connection between a diagnostic processor and a vehicle communication interface (VCI). The diagnostic processor comprises an application layer, an abstraction layer, and a connection layer. The steps of the method described by the instructions of the non-transitory computer-readable medium comprise: establishing in the connection layer a plurality of wireless communication channels between the connection layer and the VCI, generating in the abstraction layer a plurality of quality indicators for each of the communication channels, designating the communication channel with the highest associated quality indicator as a best communication channel, and transmitting data between the application layer and the VCI using the best communication channel. Each quality indicator indicates the transmission conditions of its respective communication channel. The data transmitted from the VCI is passed through the connection layer and abstraction layer to the application layer and the data transmitted from the application layer is passed through the abstraction layer and the connection layer to the VCI. In some embodiments the steps of designating the best communication channel and transmitting data using the best communication channel are performed iteratively, with the designation of the best communication channel is updated in each iteration based on the quality indicators during the instant iteration.

### BRIEF DESCRIPTION OF THE DRAWINGS

FIG. 1 is a diagrammatic hardware view of a vehicle diagnostic system having a plurality of wireless communication channels.

FIG. 2 is a diagrammatic hardware view of a vehicle diagnostic system having a plurality of wireless communication channels.

FIG. 3 is a first diagrammatic software view of a vehicle diagnostic system having a plurality of wireless communication channels.

FIG. 4 is a second diagrammatic software view of a vehicle diagnostic system having a plurality of wireless communication channels.

FIG. 5 is a third diagrammatic software view of a vehicle diagnostic system having a plurality of wireless communication channels.

FIG. 6 is a flowchart illustrating a method of seamlessly selecting a best wireless communication channel.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

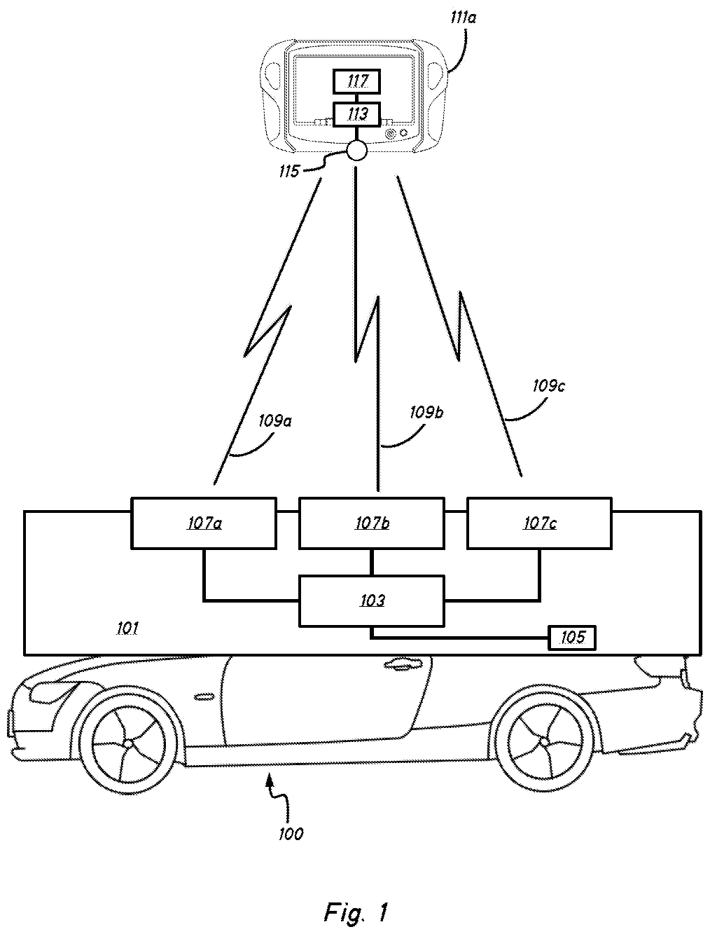

FIG. 1 is a diagrammatic hardware view of a vehicular diagnostic system for a vehicle 100, the system comprising a vehicle communication interface (VCI) 101. VCI 101 provides data communication access between a diagnostic bus (not shown) of vehicle 100, and a diagnostic device external to the vehicle 100.

VCI 101 comprises a VCI processor 103 in data communication with a VCI memory 105 and a number of VCI channel transceivers 107. VCI memory 105 may store thereon a set of instructions for VCI processor 103 and may be additionally store other data useful for the functions of VCI 101.

VCI memory 105 may be embodied as a non-transitory computer-readable storage medium or a machine-readable medium for carrying or having computer-executable instructions or data structures stored thereon. Such non-transitory computer-readable storage media or machine-readable medium may be any available media embodied in a hardware or physical form that can be accessed by a general purpose or special purpose computer. By way of example, and not limitation, such non-transitory computer-readable storage media or machine-readable medium may comprise random-access memory (RAM), read-only memory (ROM), electrically erasable programmable read-only memory (EEPROM), optical disc storage, magnetic disk storage, linear magnetic data storage, magnetic storage devices, flash memory, or any other medium which can be used to carry or store desired program code means in the form of computer-executable instructions or data structures. Combinations of the above should also be included within the scope of the non-transitory computer-readable storage media or machine-readable medium.

Computer-executable data may include instructions and other data which cause a general purpose computer, special purpose computer, or special purpose processing device to perform a certain function or group of functions. Computer-executable data may also include program modules that are executed by computers in stand-alone or network environments. Program modules may include routines, programs, objects, components, or data structures that perform particular tasks or implement particular abstract data types. Computer-executable data, associated data structures, and program modules represent examples of the program code means for executing steps of the methods disclosed herein. The particular sequence of such executable instructions or associated data structures represents examples of corresponding acts for implementing the functions described in such steps.

Each of VCI channel transceivers 107 is capable of a wireless data communication with a device external to VCI 101. In the depicted embodiment, each of VCI channel transceivers 107 comprises a singular transceiver architecture capable of both transmitting and receiving wireless communications, but in other embodiments one or more of VCI transceivers 107 may instead comprise a distinct transmitter and receiver without deviating from the teachings disclosed herein. Each of VCI transceivers 107 may be compatible with one or more wireless communication protocols, and each of VCI transceivers 107 may comprise compatibility with a distinct set of wireless communication protocols different from the other VCI transceivers 107 without deviating from the teachings disclosed herein.

Each of the VCI transceivers 107 may achieve wireless data communication via a wireless communication channel 109. In the depicted embodiment, each of the VCI transceivers 107 is in wireless data communication with a diagnostic tool 111 via each of the wireless communication channels 109. Diagnostic tool 111 comprises a diagnostic processor 113 that establishes wireless data communication with VCI 101 via a diagnostic transceiver 115. In the depicted embodiment, diagnostic transceiver 115 comprises a singular transceiver compatible with each of wireless communication channels 109, but other embodiments may comprise a different number of transceivers having different compatibilities. In some embodiments, diagnostic transceiver 115 may comprise a distinct transmitter and receiver having specialized functions for transmitting data and receiving data respectively without deviating from the teachings disclosed herein.

Diagnostic memory 117 may store thereon a set of instructions for diagnostic processor 113 and may be additionally store other data useful for the functions of diagnostic tool 111. Diagnostic memory 117 may be embodied as a non-transitory computer-readable storage medium or a machine-readable medium for carrying or having computer-executable instructions or data structures stored thereon. Such non-transitory computer-readable storage media or machine-readable medium may be any available media embodied in a hardware or physical form that can be accessed by a general purpose or special purpose computer. By way of example, and not limitation, such non-transitory computer-readable storage media or machine-readable medium may comprise random-access memory (RAM), read-only memory (ROM), electrically erasable programmable read-only memory (EEPROM), optical disc storage, magnetic disk storage, linear magnetic data storage, magnetic storage devices, flash memory, or any other medium which can be used to carry or store desired program code means in the form of computer-executable instructions or data structures. Combinations of the above should also be included within the scope of the non-transitory computer-readable storage media or machine-readable medium.

Computer-executable data may include instructions and other data which cause a general purpose computer, special purpose computer, or special purpose processing device to perform a certain function or group of functions. Computer-executable data may also include program modules that are executed by computers in stand-alone or network environments. Program modules may include routines, programs, objects, components, or data structures that perform particular tasks or implement particular abstract data types. Computer-executable data, associated data structures, and program modules represent examples of the program code means for executing steps of the methods disclosed herein. The particular sequence of such executable instructions or associated data structures represents examples of corresponding acts for implementing the functions described in such steps.

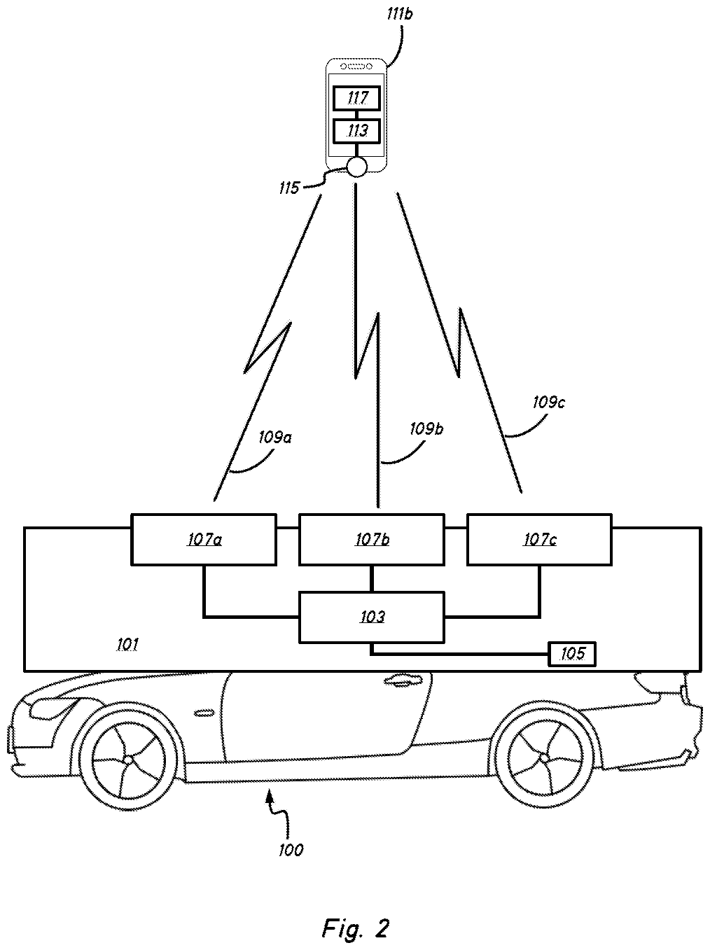

In the depicted embodiment, diagnostic tool 111 is shown as a diagnostic tablet computing device 111a, but other embodiments may comprise other configurations without deviating from the teachings disclosed herein. FIG. 2 is a diagrammatic hardware illustration of one such alternative embodiment, wherein the diagnostic tool 111 comprises a smartphone 111b, but other elements of the diagnostic system are otherwise identical.

Diagnostic tool 111 may be embodied as a mobile processing device, a smartphone, a tablet computer, a laptop computer, a wearable computing device, a desktop computer, a personal digital assistant (PDA) device, a handheld processor device, a specialized processor device, a system of processors distributed across a network, a system of processors configured in wired or wireless communication, or any other alternative embodiment known to one of ordinary skill in the art.

The wireless transmission protocols used by wireless communication channels 109 may comprise a wireless-fidelity (“Wi-Fi”) protocol, a Bluetooth protocol, or any other wireless transmission protocol known to one of ordinary skill in the art without deviating from the teachings disclosed herein. Wi-Fi protocols may include supported communication modes of a Wi-Fi standard. Bluetooth protocols may include supported profiles of a Bluetooth standard. In the depicted embodiments, wireless communication channel 109a may comprise a peer-to-peer (P2P) Wi-Fi protocol, wireless communication channel 109b may comprise a Bluetooth low energy (BLE) protocol, and wireless communication channel 109c may comprise a Wi-Fi Infrastructure protocol. Other embodiments may comprise different or additional wireless communication protocols without deviating from the teachings disclosed herein. Examples of additional Wi-Fi communication modes may include Wi-Fi Direct and Wi-Fi station mode, but other modes may be utilized without deviating from the teachings disclosed herein. Each of wireless communication channels 109 may be configured to communicate wirelessly via one or more of an RF (radio frequency) specification, cellular phone channels (analog or digital), cellular data channels, a satellite transceiver specification, infrared transmission, a Zigbee specification, Local Area Network (LAN), Wireless Local Area Network (WLAN), or any other alternative configuration, protocol, or standard known to one of ordinary skill in the art.

In the depicted embodiments, the diagnostic system comprises three wireless communication channels 109, but other embodiments may comprise a different number of wireless communication channels without deviating from the teachings disclosed herein.

Advantageously, the utilization of a plurality of wireless communication channels 109, each utilizing a distinct wireless communication protocol, provides a level of robustness for transmission between diagnostic tool 111 and VCI 105. By way of example, and not limitation, if conditions are more favorable to one particular wireless communication channel 109 than the others, then the diagnostic system may utilize that wireless communication channel 109 to optimize wireless data communication between diagnostic tool 111 and VCI 105. Additional benefits will be apparent from additional description of the teachings herein.

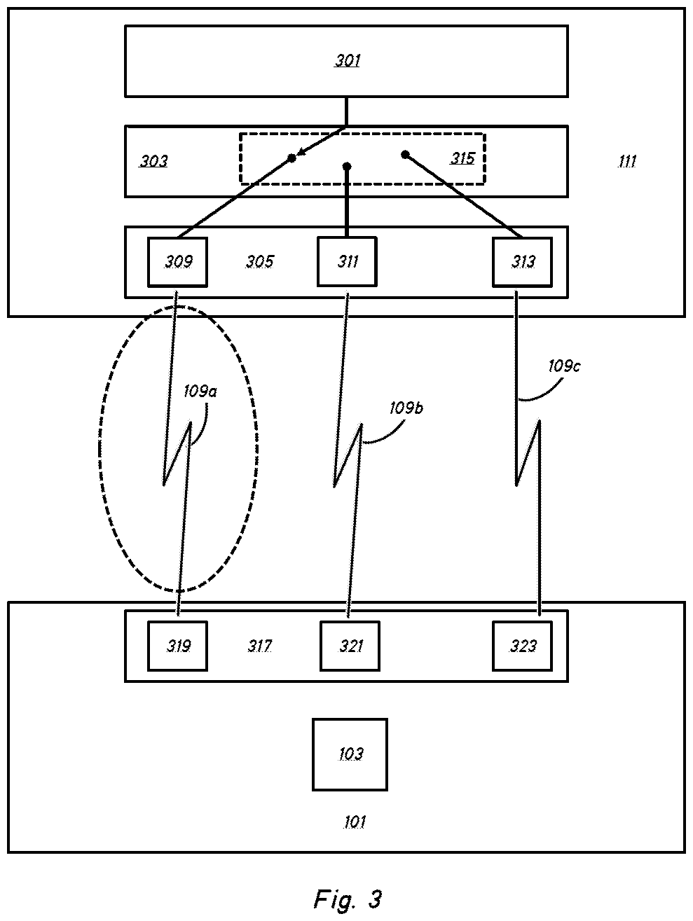

FIG. 3 is a software diagrammatic of a sub-portion of a diagnostic system, including VCI 101, diagnostic tool 111, and wireless communication channels 109. In the depicted embodiment, diagnostic tool 111 utilizes a software architecture comprising three layers for functional operation. The top layer is the application layer 301, which provides the functions necessary for human interaction with the system, including input and output functions, such as receiving commands from a user and providing a display or audible output of data or responses. Application layer 301 may comprise primarily software elements, but also firmware elements may be utilized, or a combination thereof. A second layer is the abstraction layer 303 which is an “under the hood” layer responsible for performing tasks necessary to the functionality of diagnostic tool 111, but which the user does not need to be directly informed of or interact with. Abstraction layer 303 may comprise software elements or firmware elements, or some combination thereof. Diagnostic tool 111 further utilizes a third layer in connection layer 305, which manages connectivity of diagnostic tool 111 wirelessly via the wireless communication channels 109. In the depicted embodiment, connection layer 305 comprises firmware elements, but may additionally include software elements without deviating from the teachings disclosed herein.

Connection layer 305 utilizes protocol nodes to establish and maintain wireless data communications across the wireless communication channels 109. Each of wireless communication channels 109 is associated with one of the protocol nodes of connection layer 305. The P2P Wi-Fi channel 109a is associated with a P2P Wi-Fi node 309, the Bluetooth Low Energy channel 109b is associated with a Bluetooth Low Energy node 311, and the infrastructure Wi-Fi channel 109c is associated with an infrastructure Wi-Fi node 313. Other embodiments may comprise a different configuration of nodes or additional nodes without deviating from the teachings disclosed herein.

In the abstraction layer 303, a selector 315 is utilized to choose and establish data connectivity between one of the protocol nodes within the connection layer 305 and the application layer 301. The selection of a protocol node for connection by the abstraction layer 303 is based upon transmission conditions for the wireless communication channels 109, the selection of which is described in further detail below.

VCI 101 additionally comprises its own VCI connection layer 317, which comprises its own protocol nodes 319, 321, and 323 which correspond respectively to the protocol nodes found in connection layer 305. In the depicted embodiment, VCI connection layer 317 may utilize protocol nodes comprised of software, firmware, or some combination thereof. Each of connection layer 305 and VCI connection layer 317 are responsible for operating the respective hardware components utilized for wireless data communication (such as diagnostic transceiver 115 and VCI channel transceivers 107; see FIG. 1, FIG. 2). VCI connection layer 317 is configured to receive an indication of the best channel from connection layer 305, and ensure that the corresponding protocol node is utilized to transmit and receive data between VCI 101 and diagnostic tool 111.

The abstraction layer 303 monitors the transmission quality experienced by each of wireless communication channels 109 and generates a respective quality indicator for each of the wireless communication channels 109, each of the quality indicators indicating a measured condition of its respective wireless communication channel 109. By way of example, and not limitation, a quality indicator may be a value indicative of transmission fidelity of transmission, a transmission speed, a ping signal, some combination of two or more of the above, or any other channel measurement or combination of measurements recognized by one of ordinary skill in the art without deviating from the teachings disclosed herein. In the depicted embodiment, the quality indicator may comprise a weighted value derived from a transmission fidelity measurement and a transmission speed measurement, but other embodiments may comprise different configurations without deviating from the teachings disclosed herein.

In the depicted embodiment of FIG. 3, wireless communication channel 109a is associated with a quality indicator indicating the best transmission conditions, and abstraction layer 303 correspondingly selects wireless communication channel 109a as a “best” wireless communication channel to be used for data transmission between diagnostic tool 111 and VCI 101.

Advantageously, a user interacting with application layer 301 need not be made aware of the transmission conditions of any wireless communication channel 109 provided at least 1 of the available wireless communication channels 109 provides suitable transmission conditions for operation of the functions of the application layer 301. In this manner, a user can operate diagnostic tool 111 during service operations of a vehicle without regard for the exact communication protocol being utilized at any given moment. In the depicted embodiment, wireless communication channels 109b and 109c will maintain connections while wireless communication channel 109a is utilized transmissions between the devices, providing an ongoing robust connectivity between diagnostic tool 111 and VCI 101. The remaining wireless communication channels with maintain their data connections in a “standby” operating mode, exhibiting minimal data traffic, but ready to be used in transmission at any point during operation of diagnostic tool 111. This provides the additional advantage of permitting abstraction layer 303 the ability to quickly shift to another wireless communication channel in response to a change in transmission conditions without requiring that the connection channel 305 establish a new transmission along an alternate wireless communication channel.

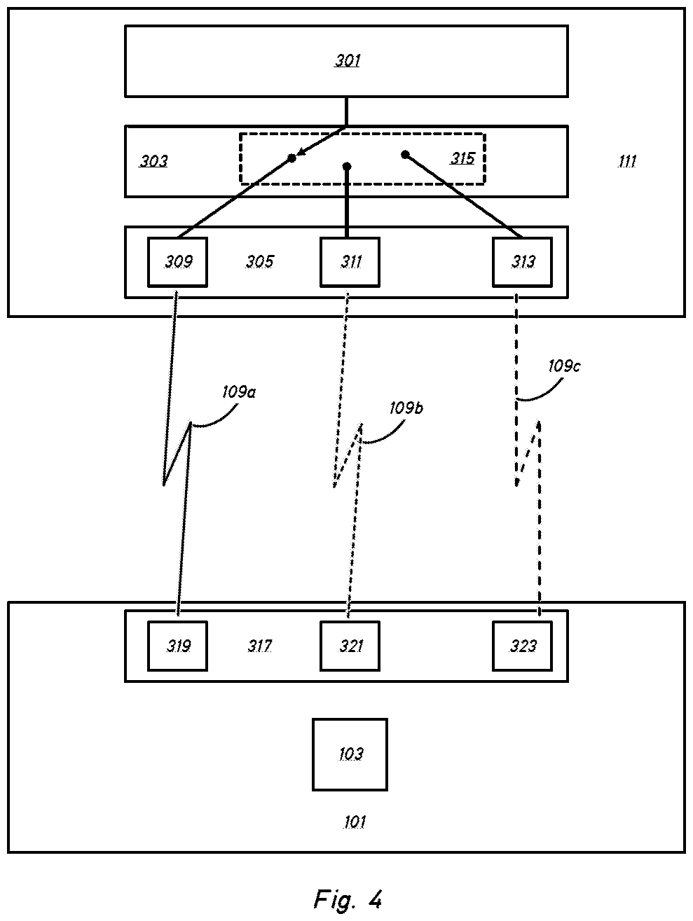

FIG. 4 illustrates the same system of FIG. 3 after continued selected of wireless communication channel 109a. In the depicted embodiment, the “best” channel is iteratively updated based upon the current transmission conditions of each of the wireless communication channels 109. In the depicted scenario, P2P Wi-Fi channel 109a continues to provide the best transmission conditions, with BLE channel 109b provides the next best transmission conditions, and infrastructure Wi-Fi channel 109c provides the third best conditions, but changes in the operating conditions may result in a different wireless communication channel providing the best transmission conditions. Advantageously, abstraction layer 303 iteratively updates the quality indicators for each of the wireless communication channels 109, and updates the best channel indicator in kind. In response to a change in the best channel indicator, selector 315 adjusts the connection for data transmission to the application layer to the new best channel.

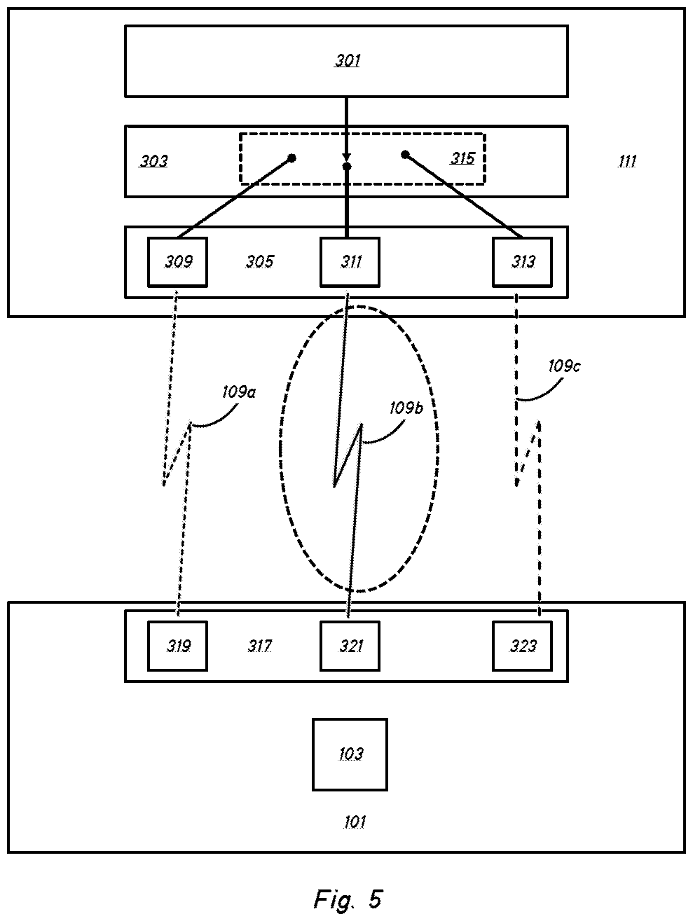

FIG. 5 provides an illustration of an updated connection made by selector 315 in response to changes in the channel conditions. In the depicted scenario, BLE channel 109b now exhibits the best channel conditions, so selector 315 makes the connection between the BLE node 311 of connection layer 305 and application layer 301.

The changeover between connections made by selector 315 is preferably seamless to the user's experience interacting with the application layer. Advantageously, the user is able to operate and interact with the diagnostic tool 111 via the application layer 301 without having to observe or otherwise acknowledge updates in the best channel.

In some embodiments, abstraction layer 303 may be configured to only switch between wireless communication channels 109 when an instant connection has a channel quality indicator showing that transmission quality has dropped below a minimum threshold value. In such embodiments, the channel quality indicator may be based upon transmission fidelity, transmission speed, a combination thereof, or one or more other measurements of channel quality known to one of ordinary skill without deviating from the teachings disclosed herein. In such embodiments, selector 315 will not adjust the connection between application layer 301 and the protocol nodes of connection layer 305 unless the quality of current “best” channel falls below the threshold value. In such an embodiment, the “best” channel may not exhibit the literal best quality indicator values after the connections has been made, but the connection will not be switched provided that the quality indicator of the current “best” channel still indicates a sufficient transmission quality for the associated wireless communication channel 109.

In some embodiments, abstraction layer 303 may generate an error message and transmit the error to the user via the application layer 301 in a circumstance where none of the wireless communication channels 109 exhibit a sufficient quality indicator value. In such circumstances, transmission conditions may be insufficient to support proper operation of the diagnostic tool 111 with respect to VCI 101 across all wireless communication channels 109.

In some embodiments, a combination of wireless communication channels 109 may be utilized in a multiplexing configuration if none of the channels exhibit sufficient transmission quality individually. In some such embodiments, a minimum of two wireless communication channels 109 may be utilized in the multiplexing configuration, but any plurality of the available communication channels 109 may be utilized without deviating from the teachings disclosed herein.

In the depicted embodiments, the iterations of quality measurements may be accomplished at regular timed intervals as dictated by a clock signal. In other embodiments, the iterations may be triggered by the current best channel transmission quality indicator falling below a threshold value. The triggering threshold value in such embodiments may be different from a minimum threshold value for all transmission without deviating from the teachings disclosed herein. The iterative process may continue until either an end condition is reached (such as the completion of a service action or in response to an end command from the user via the application layer 301).

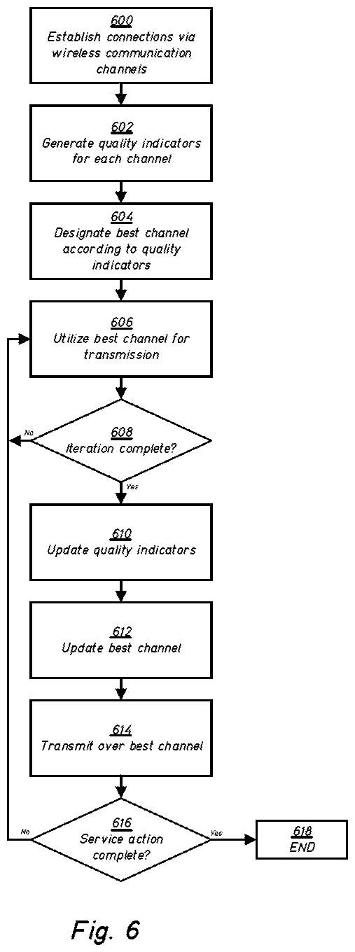

FIG. 6 is a flowchart illustrating a method of providing a seamless transmission for a diagnostic system according to one embodiment of the teachings disclosed herein. The method begins at step 600, wherein data communication connections are established via a plurality of wireless communication channels. In the depicted embodiment, each of the plurality of wireless communication channels correspond to a unique communication protocol, such as peer-to-peer wireless fidelity (“P2P Wi-Fi”), Bluetooth low energy (BLE), or infrastructure wireless fidelity (“infrastructure Wi-Fi”). The method proceeds to step 602 where quality indicators are generated for each of the plurality of wireless communication channels. The quality indicators may be derived from a measure of each respective channel's transmission fidelity, transmission speed, a weighted combination thereof, or any other measure known to ordinary skill in the art without deviating from the teachings disclosed herein.

The method then proceeds to step 604 where the quality indicators are compared and a best channel is designated according to which channel exhibits the most desirable quality indicator. In the event that two or more channels exhibit identically “best” quality indicators, a preference may be designated by a user prior to establishing connection, or a default sorting order may be utilized by the diagnostic tool without requiring user input to resolve these results.

After a best channel is designated, the best channel is utilized for data transmission at step 606. In the depicted embodiment, although the best channel is used for transmission, the other wireless communication channels are maintained in data connection with the diagnostic tool for seamless switching in the event that they later become the best channel in different operating conditions or at a different time. The channels other than the best channel are thus maintained in a standby mode, with minimal transmission of data in either direction on those channels.

The method then proceeds to step 608 to determine if it has become appropriate for an update to the best channel designation. This determination may be made according to a regular interval, such as a pre-determined interval length as dictated by a clock signal. The determination may also be in response to a detected change in transmission conditions on the best channel, or any of the other wireless communication channels. If some embodiments, a new iteration of best channel designation may not be triggered unless the quality indicator for the current best channel falls below a threshold value, but other embodiments may comprise other configurations without deviating from the teachings disclosed herein. If a new iteration is not desired, the method returns to step 606 and continues to utilize the current best channel without any additional process.

If the iteration is determined to be completed, the method continues to step 610, where the quality indicators for each of the plurality of wireless communication channels are updated. In response to the updated quality indicators, the best channel designation is updated at step 612. It is noted that best channel designation may be updated with the same channel in the event that the previous best channel still exhibits the most desirable quality indicator values. After the best channel designated is updated, the system proceeds to step 614 to continue transmission using the best channel. In the depicted embodiment, although the best channel is used for transmission, the other wireless communication channels maintain data connection with the diagnostic tool for seamless switching in the event that they later become the best channel in different operating conditions or during a future iteration. The channels other than the best channel are thus maintained in a standby mode, with minimal transmission of data in either direction on those channels.

In the depicted embodiment, the method proceeds to step 616 where it is determined if the service action has been completed. If the service action still requires additional transmission, the method returns to step 606 to continue transmitting in a fresh iteration. Otherwise, the method ends at step 618. In some embodiments, the method may maintain connection with some or all of the channels in a standby mode until the method is ended by an additional signal, such as an input from the user, without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A diagnostic system comprising:
a diagnostic processor establishing an application layer, an abstraction layer, and a connection layer; and
a vehicle communication interface (VCI) having a plurality of communication channels with the connection layer, each of the communication channels utilizing a distinct communication protocol,
wherein
the abstraction layer monitors a quality indicator of each of the plurality of communication channels, generates a best channel indicator indicating the channel with the best quality indicator, and selects a best channel based upon the best channel indicator,
the connection layer utilizes the best channel to transfer data between the VCI and the diagnostic processor, and
the abstraction layer transfers data between connection layer and the application layer.

2. The diagnostic system of claim 1, wherein the abstraction layer iteratively monitors the quality indicator of each of the plurality of communication channels, updates the best channel indicator in each iteration, and updates the best channel based upon each iterative best channel indicator.

3. The diagnostic system of claim 2, wherein the iterations occur a regular frequency dictated by a clock signal.

4. The diagnostic system of claim 1, wherein the connection layer is a first connection layer, and the VCI further comprises a second connection layer, the VCI being operable to select the best channel from the plurality of channels in response to receiving the best channel indicator from the first connection layer.

5. The diagnostic system of claim 1, wherein the plurality of communication channels comprises a Bluetooth Low Energy (BLE) channel and a wireless fidelity (Wi-Fi) channel.

6. The diagnostic system of claim 5, wherein the Wi-Fi channel is a peer-to-peer (P2P) Wi-Fi channel, and the plurality of communication channels further comprises an infrastructure Wi-Fi channel.

7. The diagnostic system of claim 1, wherein the connections of the communication channels other than the best communication channel are maintained in a standby operating mode.

8. A method of selecting a wireless connection between a diagnostic processor and a vehicle communication interface (VCI), the diagnostic processor comprising an application layer, an abstraction layer, and a connection layer, the method comprising:
establishing, in the connection layer, a plurality of wireless communication channels between the connection layer and the VCI;
generating in the abstraction layer a plurality of quality indicators for each of the communication channels, each quality indicator indicating the transmission conditions of its respective communication channel;
designating the communication channel with the highest associated quality indicator as a best communication channel; and
transmitting data between the application layer and the VCI using the best communication channel,
wherein
the data transmitted from the VCI is passed through the connection layer and abstraction layer to the application layer, and
the data transmitted from the application layer is passed through the abstraction layer and the connection layer to the VCI.

9. The method of claim 8, wherein the steps of
designating the communication channel with the highest associated quality indicator as a best communication channel and
transmitting data between the application layer and the VCI using the best communication channel
are performed iteratively, wherein the designation of the best communication channel is updated in each iteration to the communication channel associated with the highest associated quality indicator during the instant iteration.

10. The method of claim 8, wherein the connection layer is a first connection layer, and the VCI further comprises a second connection layer, the VCI selecting the best channel from the plurality of channels in response to receiving an indication from the first connection layer.

11. The method of claim 8, wherein the plurality of communication channels comprises a Bluetooth Low Energy (BLE) channel and a wireless fidelity (Wi-Fi) channel.

12. The method of claim 11, wherein the Wi-Fi channel is a peer-to-peer (P2P) Wi-Fi channel, and the plurality of communication channels further comprises an infrastructure Wi-Fi channel.

13. The method of claim 8, further comprising maintaining the connections of the communication channels other than the best communication channel in a standby operating mode.

14. A non-transitory computer-readable medium having instructions stored thereon that when read by a processor, cause the processor to perform a method of selecting a wireless connection between a diagnostic processor comprising an application layer, an abstraction layer, and a connection layer, and a vehicle communication interface (VCI), the steps comprising:
establishing, in the connection layer, a plurality of wireless communication channels between the connection layer and the VCI;
generating in the abstraction layer a plurality of quality indicators for each of the communication channels, each quality indicator indicating the transmission conditions of its respective communication channel;
designating the communication channel with the highest associated quality indicator as a best communication channel; and
transmitting data between the application layer and the VCI using the best communication channel,
wherein
the data transmitted from the VCI is passed through the connection layer and abstraction layer to the application layer, and
the data transmitted from the application layer is passed through the abstraction layer and the connection layer to the VCI.

15. The non-transitory computer-readable medium of claim 14, wherein the instructions further specify that the steps of
designating the communication channel with the highest associated quality indicator as a best communication channel and
transmitting data between the application layer and the VCI using the best communication channel
are performed iteratively, wherein the designation of the best communication channel is updated in each iteration to the communication channel associated with the highest associated quality indicator during the instant iteration.

16. The non-transitory computer-readable medium of claim 14, wherein the instructions further specify that the plurality of communication channels comprises a Bluetooth Low Energy (BLE) channel and a wireless fidelity (Wi-Fi) channel.

17. The non-transitory computer-readable medium of claim 16, wherein the instructions further specify that the Wi-Fi channel is a peer-to-peer (P2P) Wi-Fi channel, and the plurality of communication channels further comprises an infrastructure Wi-Fi channel.

18. The non-transitory computer-readable medium of claim 14, wherein the instructions further specify maintaining the connections of the communication channels other than the best communication channel in a standby operating mode.
